(19) United States
(12) Patent Application Publication
(10) Pub. No.: US 2020/0302917 A1
(43) Pub. Date: Sep. 24, 2020

(54) METHOD AND APPARATUS FOR DATA AUGMENTATION USING NON-NEGATIVE MATRIX FACTORIZATION

(71) Applicants: Electronics and Telecommunications Research Institute, Daejeon (KR); GANGNEUNG-WONJU NATIONAL UNIVERSITY INDUSTRY ACADEMY COOPERATION GROUP, Gangneung-si (KR)

(72) Inventors: Young Ho JEONG, Daejeon (KR); Sang Won SUH, Daejeon (KR); Woo-taek LIM, Daejeon (KR); SUNG WOOK PARK, Seoul (KR); HYEON GI MOON, Seoul (KR); YOUNG CHEOL PARK, Wonju-si Gangwon-do (KR); SHIN HYUK JEON, Goyang-si Gyeonggi-do (KR)

(73) Assignees: Electronics and Telecommunications Research Institute, Daejeon (KR); GANGNEUNG-WONJU NATIONAL UNIVERSITY INDUSTRY ACADEMY COOPERATION GROUP, Gangneung-si Gangwon-do (KR)

(21) Appl. No.: 16/657,605

(22) Filed: Oct. 18, 2019

(30) Foreign Application Priority Data
Mar. 18, 2019 (KR) 10-2019-0030350

(51) Int. Cl. G10L 15/16; G10L 25/03; G06N 3/08; G06N 20/00; G06F 17/16; G06F 17/27

(52) U.S. Cl. CPC G10L 15/16; G10L 25/03; G06F 17/2765; G06N 20/00; G06F 17/16; G06N 3/08

(57) ABSTRACT

A data augmentation method includes extracting one or more basis vectors and coefficient vectors corresponding to sound source data classified in advance into a target class by applying non-negative matrix factorization (NMF) to the sound source data, generating a new basis vector using the extracted basis vectors, and generating new sound source data using the generated new basis vector and the extracted coefficient vectors.

### CROSS-REFERENCE TO RELATED APPLICATION(S)

This application claims the priority benefit of Korean Patent Application No. 10-2019-0030350 filed on Mar. 18, 2019, in the Korean Intellectual Property Office, the disclosure of which is incorporated herein by reference for all purposes.

### BACKGROUND

### 1. Field

One or more example embodiments relate to a data augmentation method and apparatus using non-negative matrix factorization (NMF), and more particularly, to a data augmentation method applicable to a neural network-based sound recognition system.

### 2. Description of Related Art

A great amount of sound source data is needed to train a neural network-based sound recognition system. The neural network-based sound recognition system may need a process of training a neural network using numerous sets of sound source data. Through such process, a level of performance of the entire system may be determined. Thus, the sets of sound source data used for the training or learning may need to include various types of sound source data.

However, sets of sound source data collected in an actual environment may not include various types of sound source data. In addition, sets of sound source data may not occur concurrently, and thus the sets of sound source data may be irregular or disproportionate and a level of performance of the sound recognition system may be degraded. Thus, when there is a relatively small number of sets of data that are highly irregular or disproportionate, technology for improving a neural network-based sound recognition system through data augmentation may be needed.

### SUMMARY

An aspect provides a data augmentation method and apparatus that may augment data by generating a new basis vector using a basis vector and a coefficient vector extracted from sound source data based on non-negative matrix factorization (NMF), and generating new sound source data using the generated new basis vector and the extracted coefficient vector.

Through such data augmentation, performance of a sound recognition system may be improved even when the number of sets of data used to train a neural network is small and a level of data irregularity is high.

According to an example embodiment, there is provided a data augmentation method using NMF, including extracting one or more basis vectors and coefficient vectors corresponding to sound source data classified in advance into a target class by applying the NMF to the sound source data, generating a new basis vector using the extracted basis vectors, and generating new sound source data using the generated new basis vector and the extracted coefficient vectors.

The extracting of the basis vectors and the coefficient vectors corresponding to the sound source data may include extracting, among the basis vectors and the coefficient vectors corresponding to the sound source data, a main basis vector and a main coefficient vector that minimize a difference between the sound source data (V) and a value (W*H) obtained by multiplying a basis vector (W) and a coefficient vector (H).

The extracting of the basis vectors and the coefficient vectors corresponding to the sound source data may include performing frequency conversion on the sound source data classified into the target class, and extracting one or more basis vectors and coefficient vectors from sound source data obtained through the frequency conversion. Here, a basis vector may indicate a frequency characteristic of the sound source data, and a coefficient vector may indicate an amount or a number of components of the basis vector corresponding to the sound source data that is present in a time axis frame.

The data augmentation method may further include extracting one or more basis vectors and coefficient vectors corresponding to other sound source data belonging to the target class.

The generating of the new basis vector using the extracted basis vectors may include measuring a similarity between the extracted basis vectors using a Euclidean distance or a Mahalanobis distance, and generating the new basis vector by mixing the extracted basis vectors based on the measured similarity.

The generating of the new sound source data using the new basis vector and the extracted coefficient vectors may include generating the new sound source data based on the generated new basis vector, the extracted coefficient vectors, and phase information extracted from the sound source data classified into the target class.

According to another example embodiment, there is provided a data augmentation method using NMF, including extracting a basis vector and a coefficient vector corresponding to first sound source data classified in advance into a target class and obtained through frequency conversion by applying the NMF to the first sound source data, extracting a basis vector and a coefficient vector corresponding to second sound source data belonging to the target class, generating a new basis vector based on a similarity between the basis vector corresponding to the first sound source data and the basis vector corresponding to the second sound source data, and generating new sound source data based on the generated new basis vector and phase information extracted when the frequency conversion is performed.

According to still another example embodiment, there is provided a neural network training method to be applied to a sound recognition system, the neural network training method including training a neural network using sound source data classified into a target class and new sound source data generated based on the sound source data. The new sound source data may be generated by extracting one or more basis vectors and coefficient vectors corresponding to the sound source data by applying NMF to the sound source data classified in advance into the target class, generating a new basis vector using the extracted basis vectors, and generating the new sound source data using the generated new basis vector and the extracted coefficient vectors.

The extracted one or more basis vectors and coefficient vectors may be a main basis vector and a main coefficient vector that minimize a difference between the sound source data (V) and a value (W*H) obtained by multiplying a basis vector (W) and a coefficient vector (H) among one or more basis vectors and coefficient vectors corresponding to the sound source data.

A basis vector may indicate a frequency characteristic of the sound source data, and a coefficient vector may indicate an amount or a number of components of the basis vector corresponding to the sound source data that is present in a time axis frame.

According to yet another example embodiment, there is provided a data augmentation apparatus using NMF, including a processor and a memory configured to store computer-readable instructions. When the instructions are executed in the processor, the processor may extract one or more basis vectors and coefficient vectors corresponding to sound source data classified in advance into a target class by applying the NMF to the sound source data, generate a new basis vector using the extracted basis vectors, and generate new sound source data using the generated new basis vector and the extracted coefficient vectors.

When extracting the basis vectors and the coefficient vectors corresponding to the sound source data, the processor may extract, among the basis vectors and the coefficient vectors corresponding to the sound source data, a main basis vector and a main coefficient vector that minimize a difference between the sound source data (V) and a value (W*H) obtained by multiplying a basis vector (W) and a coefficient vector (H).

When extracting the basis vectors and the coefficient vectors corresponding to the sound source data, the processor may perform frequency conversion on the sound source data classified into the target class, and extract one or more basis vectors and coefficient vectors from sound source data obtained through the frequency conversion. Here, a basis vector may indicate a frequency characteristic of the sound source data, and a coefficient vector may indicate an amount or a number of components of the basis vector corresponding to the sound source data that is present in a time axis frame.

The processor may extract one or more basis vectors and coefficient vectors corresponding to other sound source data belonging to the target class.

When generating the new basis vector using the extracted basis vectors, the processor may measure a similarity between the extracted basis vectors using a Euclidean distance or a Mahalanobis distance, and generate the new basis vector by mixing the extracted basis vectors based on the measured similarity.

When generating the new sound source data using the new basis vector and the extracted coefficient vectors, the processor may generate the new sound source data based on the generated new basis vector, the extracted coefficient vectors, and phase information extracted from the sound source data classified into the target class.

According to further another example embodiment, there is provided a data augmentation apparatus using NMF, including a processor and a memory configured to store computer-readable instructions. When the instructions are executed in the processor, the processor may extract a basis vector and a coefficient vector corresponding to first sound source data classified in advance into a target class and obtained through frequency conversion by applying the NMF to the first sound source data, extract a basis vector and a coefficient vector corresponding to second sound source data belonging to the target class, generate a new basis vector based on a similarity between the basis vector corresponding to the first sound source data and the basis vector corresponding to the second sound source data, and generate new sound source data based on the generated new basis vector and phase information extracted when the frequency conversion is performed.

According to still another example embodiment, there is provided a neural network training apparatus to be applied to a sound recognition system, the neural network training apparatus including a processor and a memory configured to store computer-readable instructions. When the instructions are executed in the processor, the processor may train a neural network using sound source data classified into a target class and new sound source data generated based on the sound source data. The new sound source data may be generated by extracting one or more basis vectors and coefficient vectors corresponding to the sound source data by applying NMF to the sound source data classified in advance into the target class, generating a new basis vector using the extracted basis vectors, and generating the new sound source data using the generated new basis vector and the extracted coefficient vectors.

The one or more extracted basis vectors and coefficient vectors may be a main basis vector and a main coefficient vector that minimize a difference between the sound source data (V) and a value (W*H) obtained by multiplying a basis vector (W) and a coefficient vector (H) among one or more basis vectors and coefficient vectors corresponding to the sound source data.

Here, a basis vector may indicate a frequency characteristic of the sound source data, and a coefficient vector may indicate an amount or a number of components of the basis vector corresponding to the sound source data that is present in a time axis frame.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a flowchart illustrating an example of a data augmentation method using non-negative matrix factorization (NMF) according to an example embodiment;

FIG. 2 is a flowchart illustrating an example of extracting a basis vector and a coefficient vector from sound source data classified into a target class according to an example embodiment;

FIG. 3 is a flowchart illustrating an example of generating a new basis vector using an extracted basis vector according to an example embodiment;

FIG. 4 is a flowchart illustrating an example of generating mixed sound source data based on a new basis vector generated as illustrated in FIG. 3;

FIG. 5 is a diagram illustrating an example of a relationship between a basis vector matrix and a coefficient vector matrix corresponding to a sound source spectrum matrix obtained from sound source data through frequency conversion according to an example embodiment;

FIG. 6 is a diagram illustrating an example of generating a new basis vector according to an example embodiment; and

FIG. 7 is a diagram illustrating an example of a data augmentation apparatus performing a data augmentation method according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

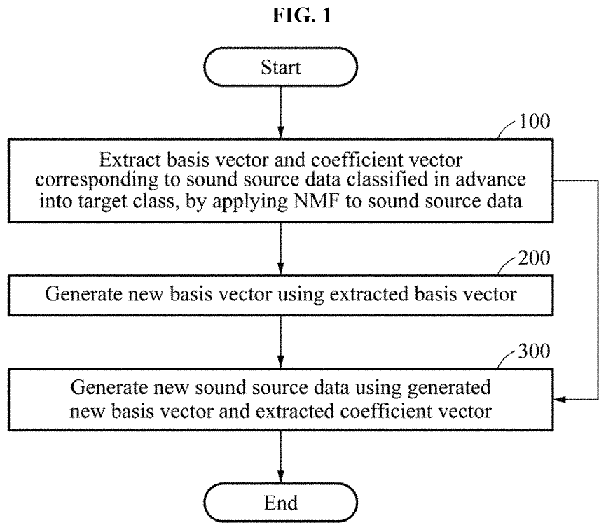

FIG. 1 is a flowchart illustrating an example of a data augmentation method using non-negative matrix factorization (NMF) according to an example embodiment.

In an example, a neural network-based sound recognition system may be applied to, for example, a smart vehicle, an autonomous rotating closed-circuit television (CCTV), an artificial intelligence (AI) speaker, and the like. For an effective operation of the sound recognition system, a neural network to be applied thereto may need to be trained through a great amount of sound source data collected in an actual environment. However, to train the neural network, classification may need to be performed first to classify each set of sound source data into a corresponding class before the training. Here, such class classification is also referred to as annotation. In addition, sets of sound source data collected in an actual environment may not have a same probability of occurrence, and thus a level of irregularity between the sets of sound source data may be relatively high. In such a case of high irregularity, a level of performance of the sound recognition system may be degraded. Thus, when sound source data needed to train the neural network is relatively less in amount and has a relatively high level of irregularity, data augmentation using NMF may be applied to improve a level of performance of the neural network-based sound recognition system.

Referring to FIG. 1, in operation 100, a data augmentation apparatus extracts at least one basis vector and at least one coefficient vector corresponding to sound source data classified in advance into a target class by applying NMF to the sound source data.

Before the neural network applied to the sound recognition system is trained, classification may be performed to classify sets of sound source data into classes. There may be one or more classes, and each of the classes may include sound source data. For example, there may be classes 1 through N, and the classes 1 through N may include different sets of sound source data. In this example, a class including sound source data corresponding to a basis vector and a coefficient vector to be extracted may be a target class among the one or more classes. The sound source data corresponding to the basis vector and the coefficient vector to be extracted may be classified into the target class before the training of the neural network.

The basis vector and the coefficient vector corresponding to the sound source data may be extracted by applying the NMF to the sound source data belonging to the target class. The NMF of which all components are non-negative may decompose the sound source data through approximation using a linear combination of basis vectors. Here, a basis vector may indicate a frequency characteristic of sound source data, and a coefficient vector may indicate an amount or number of components of the basis vector corresponding to the sound source data that are present in a time axis frame.

The sound source data belonging to the target class may be subject to frequency conversion, and a matrix V may be represented by a combination of a basis vector and a coefficient vector as represented by Equation 1 below by applying the NMF.

V_{m×n}≈W_{m×r}H_{r×n} [Equation 1]

In Equation 1, V_{(m×n)} denotes a matrix indicating a sound source spectrum obtained from the sound source data belonging to the target class through the frequency conversion, and consists of an element Vᵢⱼ in which j denotes a time index and i denotes an i-th frequency conversion value. In addition, W_{(m×r)} denotes a matrix indicating a basis vector, which consists of r basis vectors W_{k(m×1)}. H_{(r×n)} denotes a matrix indicating a coefficient vector, which consists of coefficient vectors Hₖ^{r}(1×n) corresponding to the r basis vectors based on a time index of j. Here, T denotes a transposed matrix.

To calculate the matrix indicating a basis vector and the matrix indicating a coefficient vector that satisfy Equation 1, Equation 2 may be calculated as below.

$$W ( n + 1 ) = W ( n ) \cdot \frac{{VH}^{T} ( n )}{W ( n ) H ( n ) {H}^{T} ( n )} \\ H ( n + 1 ) = H ( n ) \cdot \frac{{W ( n )}^{T} V}{{W ( n )}^{T} W ( n ) H ( n )} \qquad [ Equation 2 ]$$

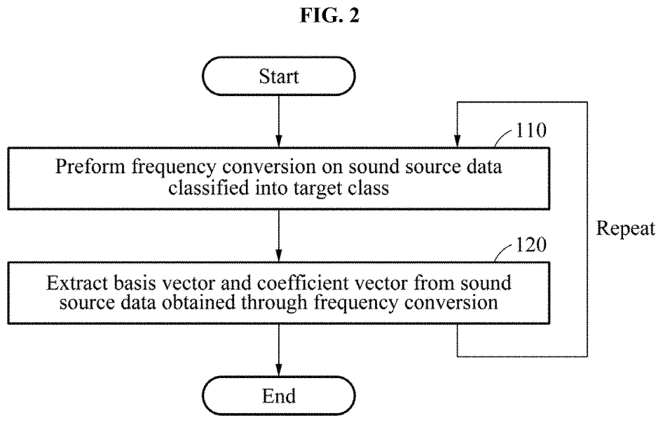

In Equation 2, ⋅ denotes an inner product, and n denotes the number of repetitions to be described hereinafter with reference to FIG. 2. The number n of repetitions may be the number of times of repetitions performed until Equation 3 is minimized, and the basis vector and the coefficient vector of Equation 2 may be concurrently updated.

∥V−WH∥² [Equation 3]

When Equation 3 is minimized, the r basis vectors Wₖ and the r coefficient vectors Hₖ^{T} may be a main basis vector corresponding to the matrix V indicating the sound source spectrum corresponding to the sound source data belonging to the target class, and a main coefficient vector corresponding to the main basis vector. The number r of basis vectors obtained using Equation 3 may be selected using (n+m)*r<n*m, and a basis vector obtained based on the selected r may indicate the main basis vector.

In an example, the data augmentation apparatus may extract at least one basis vector and at least one coefficient vector corresponding to other sound source data by applying NMF to the other sound source data classified in advance into the target class. Here, the sound source data classified in advance into the target class and obtained through the frequency conversion may be referred to as first sound source data, and the other sound source data classified in advance into the target class may be referred to as second sound source data. That is, a basis vector and a coefficient vector corresponding to each of the first sound source data and the second sound source data may be extracted.

In operation 200, the data augmentation apparatus generates a new basis vector using the extracted basis vector.

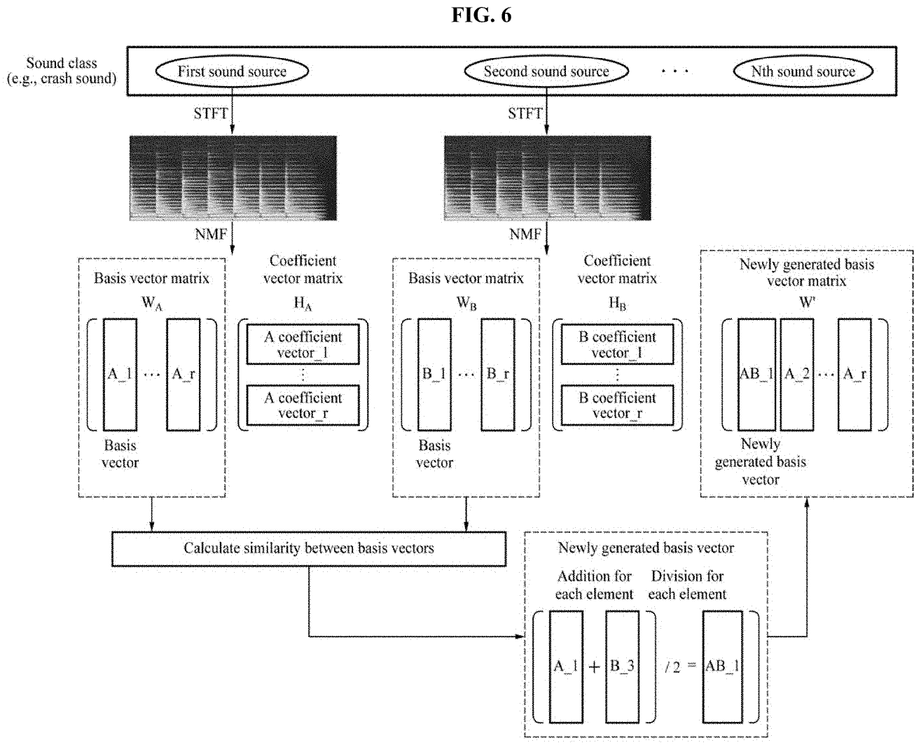

The data augmentation apparatus may measure a similarity between extracted one or more basis vectors. The similarity between the extracted one or more basis vectors may be measured using a Euclidean distance or a Mahalanobis distance. For example, by applying the NMF to each of the first sound source data and the second sound source data, a plurality of different basis vectors and coefficient vectors may be obtained. In this example, a similarity between an obtained basis vector corresponding to the first sound source data and an obtained basis vector corresponding to the second sound source data may be analyzed. FIG. 6 is a diagram illustrating an example of generating a new basis vector according to an example embodiment. As illustrated in FIG. 6, a new basis vector may be generated by mixing similar basis vectors, and various basis vectors that may not be extracted from training data used to train a neural network may be generated.

For example, a basis vector is extracted from the first sound source data, and a basis vector is extracted from the second sound source data. A similarity between the basis vectors is measured based on a Euclidean distance or a Mahalanobis distance. Through the measurement, vectors having a minimum distance value may have a greatest similarity therebetween. That is, as illustrated in FIG. 6, a similarity between a basis vector A_1 among r basis vectors A_1 through A_r corresponding to the first sound source data, and each of r basis vectors B_1 through B_r is measured. In this example, when a basis vector B_3 has a minimum distance value with the basis vector A_1, the basis vector B_3 may be determined to be the most similar basis vector to the basis vector A_1. Thus, using the basis vectors A_1 and B_3, in lieu of the basis vectors A_1 and B_1, a new basis vector AB_1, for example, AB_1=(A_1+B_3)/2), may be generated.

Here, a new basis vector generated using a similarity may have a characteristic of a main basis vector corresponding to sound source data classified into a target class.

Referring back to FIG. 1, in operation 300, the data augmentation apparatus generates new sound source data using the new basis vector and the extracted coefficient vector.

The data augmentation apparatus may generate a sound source spectrum using the new basis vector generated in operation 200 and the coefficient vector extracted in operation 100. The generated sound source spectrum, which is V′, may consist of an element V′ᵢⱼ which is represented by Equation 4. In Equation 4, W′ denotes the new basis vector generated in operation 200, and H denotes a coefficient vector extracted in operation 100.

$${V}_{ij}^{′} = {\sum }_{k = 0}^{r} {W}_{ik}^{′} {H}_{ki} \qquad [ Equation 4 ]$$

In operation 100, the data augmentation apparatus extracts phase information when performing the frequency conversion on the sound source data belonging to the target class. The data augmentation apparatus generates the new sound source data by mixing the generated sound source spectrum and the phase information extracted in operation 100. For example, by applying a short-time Fourier transform (STFT) to a time domain signal, a magnitude and a phase may be derived. The generated V′ may be a spectrum component in a frequency domain, on which an inverse short-time Fourier transform (ISTFT) may be perform using the phase information extracted in operation 100 to generate the time domain signal.

In an example, the data augmentation apparatus may generate multiple sets of mixed sound source data from a relatively small number of training data, for example, the sound source data classified into the target class. In addition, the new basis vector W′ may be generated from annotated sound source data, which is sound source data classified in advance into a target class, and thus an additional annotation process may not be needed. Thus, a cost and an amount of time required for the annotation may be reduced.

In another example, the data augmentation apparatus may effectively generate sound source data of a specific target class, and may thus be used to resolve an issue of an irregularity between sets of data that may occur because they do not have a same probability of occurrence in an actual environment.

FIG. 2 is a flowchart illustrating an example of extracting a basis vector and a coefficient vector from sound source data classified into a target class according to an example embodiment. Hereinafter, detailed operations of operation 100 of FIG. 1 will be described with reference to FIG. 2.

Referring to FIG. 2, in operation 110, the data augmentation apparatus performs frequency conversion on at least one set of sound source data classified into a target class.

At least one set of sound source data may be classified into a target class among a plurality of classes. For example, first sound source data and second sound source data, through Nth sound source data may be classified in advance into a target class among a plurality of classes. In this example, the data augmentation apparatus may perform frequency conversion on the first sound source data and the second sound source data through the Nth sound source data that are classified into the target class.

In operation 120, the data augmentation apparatus extracts a basis vector and a coefficient vector from the sound source data obtained through the frequency conversion.

The data augmentation apparatus may extract a main basis vector satisfying Equations 2 and 3 above with respect to the first sound source data obtained through the frequency conversion and satisfying Equation 1 above, and extract a coefficient vector corresponding to the main basis vector. In addition, the data augmentation apparatus may extract a main basis vector satisfying Equations 2 and 3 above with respect to the second sound source data obtained through the frequency conversion and satisfying Equation 1 above, and extract a coefficient vector corresponding to the main basis vector. Similarly, the data augmentation apparatus may extract a main basis vector satisfying Equations 2 and 3 above with respect to the Nth sound source data obtained through the frequency conversion and satisfying Equation 1 above, and extract a coefficient vector corresponding to the main basis vector.

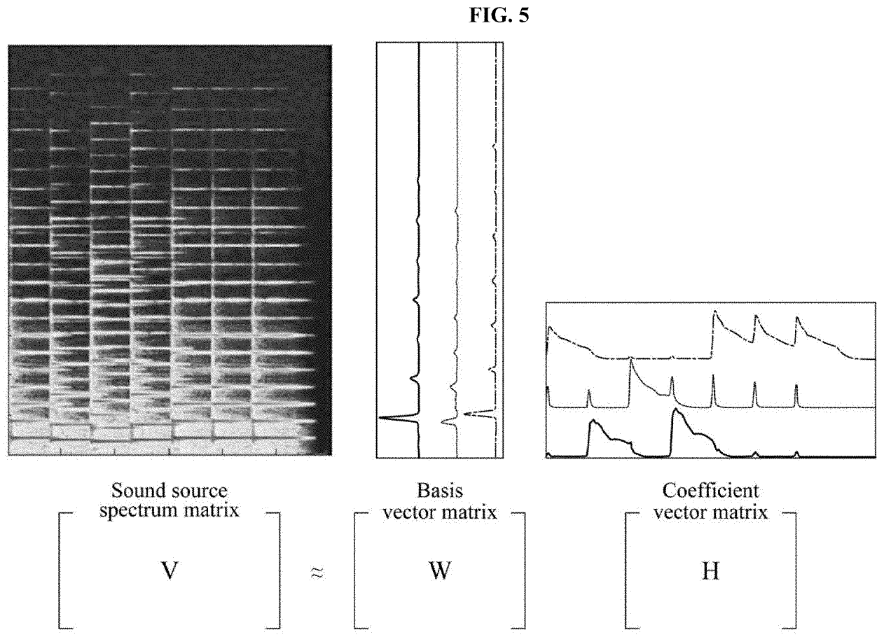

The data augmentation apparatus may update a basis vector and a coefficient vector through repetitions until Equation 3 is minimized, and determine a main basis vector and a coefficient vector corresponding to the main basis vector. FIG. 5 is a diagram illustrating an example of a relationship between a basis vector matrix and a coefficient vector matrix corresponding to a sound source spectrum matrix obtained from sound source data through frequency conversion according to an example embodiment.

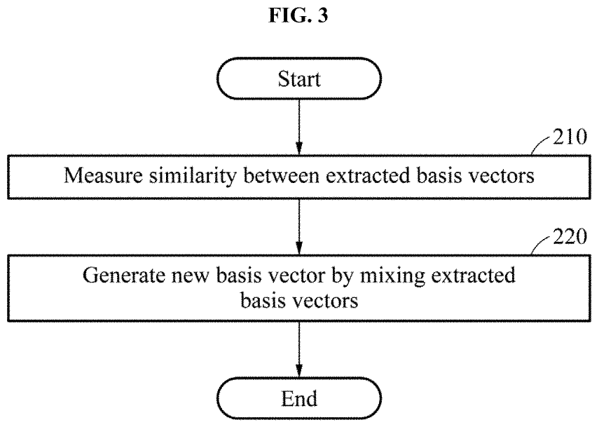

FIG. 3 is a flowchart illustrating an example of generating a new basis vector using an extracted basis vector according to an example embodiment. Hereinafter, detailed operations of operation 200 of FIG. 1 will be described with reference to FIG. 3.

Referring to FIG. 3, in operation 210, the data augmentation apparatus measures a similarity between extracted basis vectors. The data augmentation apparatus measures the similarity between the extracted basis vectors using a Euclidean distance and a Mahalanobis distance. For example, the data augmentation apparatus measures a similarity between a main basis vector extracted from first sound source data and each of main basis vectors extracted from second sound source data through Nth sound source data.

In operation 220, the data augmentation apparatus generates a new basis vector by mixing the extracted basis vectors.

For example, the data augmentation apparatus may generate the new basis vector by mixing a main basis vector extracted from the first sound source data, and a main basis vector extracted from the second sound source data and most similar to the main basis vector extracted form the first sound source data.

For another example, top three main basis vectors similar to a main basis vector extracted from first sound source data may include a main basis vector extracted from second sound source data, a main basis vector extracted from fifth sound source data, and a main basis vector extracted from seventh sound source data. Thus, the data augmentation apparatus may generate a new basis vector by mixing the main basis vector extracted from the first sound source data, the main basis vector extracted from the second sound source data, the main basis vector extracted from the fifth sound source data, and the main basis vector extracted from the seventh sound source data.

Here, such generated new basis vector may reflect characteristics of main basis vectors of sets of sound source data classified into a target class. In addition, various basis vectors that may not be extracted from training data required to train a neural network, for example, a small number of sets of sound source data classified into a target class, may be generated through the operations described above with reference to FIG. 3.

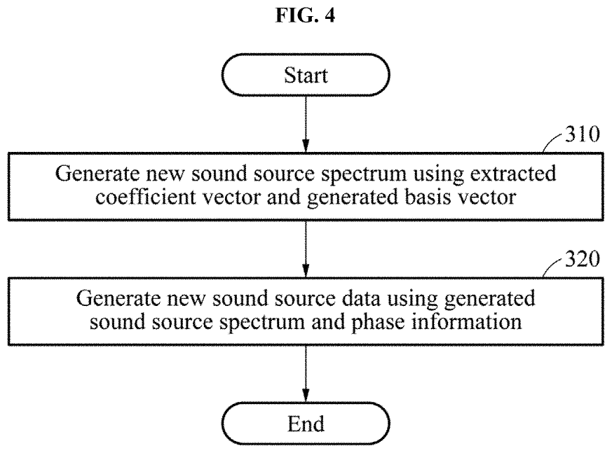

FIG. 4 is a flowchart illustrating an example of generating mixed sound source data based on a new basis vector generated as illustrated in FIG. 3. Hereinafter, detailed operations of operation 300 of FIG. 1 will be described with reference to FIG. 4.

Referring to FIG. 4, in operation 310, the data augmentation apparatus generates a new sound source spectrum using an extracted coefficient vector and a generated basis vector.

The extracted coefficient vector may be the coefficient vector extracted in operation 120 described above with reference to FIG. 2, and the generated basis vector may be the basis vector generated in operation 220 described above with reference to FIG. 3.

In detail, in operation 120 of FIG. 2, the data augmentation apparatus applies NMF to extract a basis vector and a coefficient vector corresponding to first sound source data, and extract a basis vector and a coefficient vector corresponding to second sound source data. In this example, a new basis vector is generated based on a similarity between the basis vector corresponding to the first sound source data and the basis vector corresponding to the second sound source data. Thus, the data augmentation apparatus generates the new sound source spectrum based on the generated new basis vector, and the coefficient vector extracted from the first sound source data and/or the second sound source data.

In operation 320, the data augmentation apparatus generates new sound source data using the generated sound source spectrum and phase information. The phase information may be extracted through frequency conversion performed on sound source data belonging to a target class.

According to an example embodiment, the data augmentation apparatus may generate multiple sets of mixed sound source data from a relatively small number of training data, for example, sound source data classified into a target class. In addition, a new basis vector W′ may be generated from the sound source data that is annotated, or previously classified into the target class, and thus an additional annotation process may not be required. Thus, a cost and a time required for the annotation process may be saved. In addition, the data augmentation apparatus may effectively generate sound source data of a certain target class, and thus may be used to resolve an issue of irregularity between sets of data that may occur because they do not have a same probability of occurrence in an actual environment.

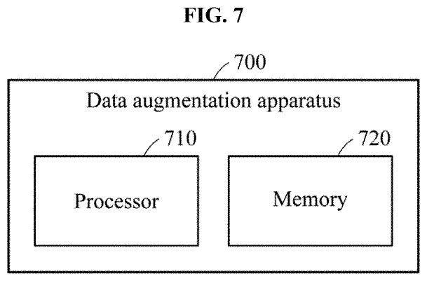

FIG. 7 is a diagram illustrating an example of a data augmentation apparatus performing a data augmentation method according to an example embodiment. Referring to FIG. 7, a data augmentation apparatus 700 includes a processor 710 and a memory 720. The memory 720 my include a computer-readable instruction. When the processor 710 reads the instruction included in the memory 720, mixed sound source data may be generated from sound source data classified in advance into a target class through the methods and operations described above with reference to FIGS. 1 through 5.

The data augmentation apparatus 700 may be included in a training apparatus of a neural network, and the training apparatus of the neural network may be used to learn data augmented by the data augmentation apparatus 700. Thus, even in a case in which the number of sets of data is relatively less and the sets of data are highly irregular, it is possible to improve a level of performance of a sound recognition system by the neural network learning the data augmented through the methods and operations described herein.

According to an example embodiment described herein, there is provided a data augmentation method using NMF. The data augmentation method may augment data by generating a new basis vector using a basis vector and a coefficient vector extracted from sound source data based on NMF, and generating new sound source data using the generated new basis vector and the extracted coefficient vector.

According to an example embodiment described herein, there is provided a data augmentation method using NMF. The data augmentation method may be used to improve a level of performance of a sound recognition system through data augmentation when the number of sets of data to be used to train a neural network is relatively small and a data irregularity is relatively high.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A data augmentation method using non-negative matrix factorization (NMF), comprising:
extracting one or more basis vectors and coefficient vectors corresponding to sound source data classified in advance into a target class by applying the NMF to the sound source data;
generating a new basis vector using the extracted basis vectors; and
generating new sound source data using the generated new basis vector and the extracted coefficient vectors.

2. The data augmentation method of claim 1, wherein the extracting of the basis vectors and the coefficient vectors corresponding to the sound source data comprises:
extracting, among the basis vectors and the coefficient vectors corresponding to the sound source data, a main basis vector and a main coefficient vector that minimize a difference between the sound source data (V) and a value (W*H) obtained by multiplying a basis vector (W) and a coefficient vector (H).

3. The data augmentation method of claim 1, wherein the extracting of the basis vectors and the coefficient vectors corresponding to the sound source data comprises:
performing frequency conversion on the sound source data classified into the target class, and extracting one or more basis vectors and coefficient vectors from sound source data obtained through the frequency conversion,
wherein a basis vector indicates a frequency characteristic of the sound source data, and a coefficient vector indicates an amount of components of the basis vector corresponding to the sound source data that is present in a time axis frame.

4. The data augmentation method of claim 3, further comprising:
extracting one or more basis vectors and coefficient vectors corresponding to other sound source data belonging to the target class.

5. The data augmentation method of claim 1, wherein the generating of the new basis vector using the extracted basis vectors comprises:
measuring a similarity between the extracted basis vectors using a Euclidean distance or a Mahalanobis distance; and
to generating the new basis vector by mixing the extracted basis vectors based on the measured similarity.

6. The data augmentation method of claim 1, wherein the generating of the new sound source data using the new basis vector and the extracted coefficient vectors comprises:
generating the new sound source data based on the generated new basis vector, the extracted coefficient vectors, and phase information extracted from the sound source data classified into the target class.

7. A data augmentation method using non-negative matrix factorization (NMF), comprising:
extracting a basis vector and a coefficient vector corresponding to first sound source data classified in advance into a target class and obtained through frequency conversion by applying the NMF to the first sound source data;
extracting a basis vector and a coefficient vector corresponding to second sound source data belonging to the target class;
generating a new basis vector based on a similarity between the basis vector corresponding to the first sound source data and the basis vector corresponding to the second sound source data; and
generating new sound source data based on the generated new basis vector and phase information extracted when the frequency conversion is performed.

8. A neural network training method to be applied to a sound recognition system, comprising:
training a neural network using sound source data classified into a target class and new sound source data generated based on the sound source data,
wherein the new sound source data is generated by extracting one or more basis vectors and coefficient vectors corresponding to the sound source data by applying non-negative matrix factorization (NMF) to the sound source data classified in advance into the target class, generating a new basis vector using the extracted basis vectors, and generating the new sound source data using the generated new basis vector and the extracted coefficient vectors.

9. The neural network training method of claim 8, wherein the extracted one or more basis vectors and the extracted one or more coefficient vectors are a main basis vector and a main coefficient vector that minimize a difference between the sound source data (V) and a value (W*H) obtained by multiplying a basis vector (W) and a coefficient vector (H) among one or more basis vectors and coefficient vectors corresponding to the sound source data.

10. The neural network training method of claim 8, wherein a basis vector indicates a frequency characteristic of the sound source data, and a coefficient vector indicates an amount of components of the basis vector corresponding to the sound source data that is present in a time axis frame.
